(19) United States
(12) Patent Application Publication
(10) Pub. No.: US 2018/0340698 A1
(43) Pub. Date: Nov. 29, 2018

(54) DEVICE FOR GUIDING MATERIAL, NOTABLY LIQUID, FILM FOR SUCH A DEVICE AND KIT COMPRISING SUCH A DEVICE

(71) Applicant: Jean Louis RAGONE, Plan de Cuques (FR)

(72) Inventor: Jean Louis RAGONE, Plan de Cuques (FR)

(21) Appl. No.: 15/778,201

(22) PCT Filed: Nov. 23, 2016
(86) PCT No.: PCT/FR2016/053062

§ 371 Date: May 22, 2018

(30) Foreign Application Priority Data
Nov. 23, 2015 (FR) 1561272

(51) Int. Cl. F24D 19/08; B60H 1/32; F25D 21/06

(52) U.S. Cl. CPC F24D 19/088; F25D 21/065; B60H 1/3233

(57) ABSTRACT

The present invention targets a device (10) for guiding material, which comprises:
a peripheral jaw (105) following a closed contour and referred to as “first jaw”,
a removable jaw (110) referred to as “second jaw” of a profile (120) that corresponds, at least partially, to the profile (115) of the first jaw, interlocking with the first jaw and immobilizing a film (125) of impervious material,
a manipulating handle (130) connected to the first jaw for manipulating the device.

The present invention also targets a film for such a device, the dimensions of which exceed the dimensions of the jaws of the guide device.

The present invention also targets a kit comprising such a device and such an impervious film.

### TECHNICAL FIELD OF THE INVENTION

The present invention envisages a device for guiding material, notably liquid, an impervious bag for this device, and a kit comprising such a device.

It applies, in particular, to the plumbing, chimney-sweeping and woodworking fields. More specifically, the invention applies to any field in which a fluid must be guided, as in the case of draining operations for example.

### STATE OF THE ART

Currently, in order to guide a liquid whose source is difficult to access, such as a drain valve of a water heater or radiator, users use rigid devices that are difficult to position. In addition, these rigid devices do not have the dimension or shape allowing them to be placed close to wall angles or near the floor. Moreover, the rigidity of such devices limits the amount of liquid that the device can contain. Therefore, if there is to be a large amount of liquid, the dimensions of the device need to be considerable, which makes the manipulation of such a device even less easy when the device is empty than when the device is at least partially filled.

Documents FR 3 009 600 and US 2004/227347 are known, which describe devices for holding water to be fixed on pipes during interventions. These devices are complicated to use and require lengthy manipulations.

### SUBJECT OF THE INVENTION

The present invention aims to remedy all or part of these drawbacks.

To this end, according to a first aspect, the present invention envisages a device for guiding material, notably liquid, which comprises, on a closed contour:

a peripheral jaw, referred to as “first jaw”, having a profile;

a removable jaw, referred to as “second jaw”, with a profile that corresponds, at least partially, to the profile of the first jaw, interlocking with the first jaw to immobilize a film between said jaws; and

a manipulating handle secured to at least one of the jaws for manipulating the device.

Thanks to these provisions, the plastic film is held between the jaws, and the opening of the first jaw allows the device to be easily guided around the source of material, especially liquid, such that there are no leaks and all of the material is contained within the impervious bag. In addition, as the device is a guide, the opening is held higher than the film made of an impervious material, and only the dimensions of the film limit the capacity for storing material.

In some embodiments, the curvature of the profile of the first jaw changes sign at least twice.

Thanks to these provisions, the impervious film is kept between the jaws of the device and a risk of the film slipping between the jaws is averted.

In some embodiments, the closed contour is planar.

These embodiments have the advantage that the device can be easily arranged around flat surfaces, such as walls for example.

In some embodiments, the closed contour has a generally rectangular shape.

The advantage of these embodiments is that they make manipulation easier for the user.

In some embodiments, the manipulating handle comprises material reinforcements.

Thanks to these provisions, the handle can withstand greater bending forces.

In some embodiments, at least one jaw is made of PVC (acronym for “PolyVinyl Chloride”).

The advantage of these embodiments is that they make the device less costly to produce. In addition, the device is light and therefore more easily manipulated by a user, while having sufficient mechanical characteristics.

In some embodiments, at least one jaw is produced by molding.

These embodiments enable the devices to be mass-produced.

In some embodiments, the impervious film comprises a drain valve.

Such impervious films allow the liquid to be guided from its source to an identified location, such as a drain, or one or more recipients, controlling the amount of liquid deposited.

In some embodiments, the impervious film is made of a plastic material at least partially transparent to visible wavelengths.

The advantage of these embodiments is that they enable a user to see the limits of the material in the impervious bag so as to close it for moving without mishap.

In some embodiments, the device that is the subject of the present invention comprises a spatula.

Thanks to these provisions, by sliding over a surface bearing material to be collected, a portion of this material is collected.

In some embodiments, at least one of the jaws has a broadly rectangular shape, with apexes possibly rounded or flattened to form an octagon, the length of the shorter side of this rectangle preferably being between 15 and 25 centimeters.

In some embodiments, at least one of the jaws has a broadly rectangular shape, with apexes possibly rounded or flattened to form an octagon, the length of the longer side of this rectangle preferably being between 21 and 35 centimeters.

The inventor has determined that these dimensions allow for collection over a large surface area without excessive bulk.

In some embodiments, the device that is the subject of the present invention has feet.

In some embodiments, the device that is the subject of the present invention is equipped with suspension straps, ropes or wires.

In some embodiments, the device that is the subject of the present invention is equipped with a belt.

Thanks to each of these provisions, the device can be kept in a working position without the user having to hold it by its handle.

In some embodiments, the device that is the subject of the present invention is equipped with a light source, an electrical power supply for this light source, and a switch.

The user can therefore light the work area, especially when it is in the dark, for example behind a water heater, hot-water tank or radiator, or under a sink, washbasin or bath.

According to a second aspect, the present invention envisages a film made of an impervious material for a guide device that is the subject of the present invention, the dimensions of which are greater than the dimensions of the jaws of the guide device.

As the particular aims, advantages and features of the film that is the subject of the present invention are similar to those of the device that is the subject of the present invention, they are not repeated here.

According to a third aspect, the present invention envisages a kit comprising at least one device that is the subject of the present invention, and at least one bag made of an impervious material, the perimeter of whose opening is larger than the perimeter of the jaws of the guide device.

As the particular aims, advantages and features of the kit that is the subject of the present invention are similar to those of the device that is the subject of the present invention, they are not repeated here.

### BRIEF DESCRIPTION OF THE FIGURES

Other particular advantages, aims and features of the invention will become apparent from the non-limiting description that follows of at least one particular embodiment of a device for guiding material, notably liquid, an impervious bag for this device, and a kit comprising such a device, the subjects of the present invention, with reference to drawings included in an appendix, wherein:

FIG. 1 represents, schematically and in plan, a first particular embodiment of the device that is the subject of the present invention;

FIG. 2 represents, schematically, a cross-section of the first particular embodiment of the device that is the subject of the present invention;

FIG. 3 represents, schematically and in a top view, a third view of the first particular embodiment of the device that is the subject of the present invention;

FIG. 4 represents, schematically and in plan, a first particular embodiment of a kit that is the subject of the present invention; and

FIG. 5 represents, in a plan view and side view, a variant of the device illustrated in FIGS. 1 to 3.

### DESCRIPTION OF EXAMPLES OF REALIZATION OF THE INVENTION

The present description is given in a non-limiting way, each characteristic of an embodiment being able to be combined with any other characteristic of any other embodiment in an advantageous way. In addition, each parameter of an example of realization can be utilized independently from the other parameters of said example of realization.

It is now noted that the figures are to scale.

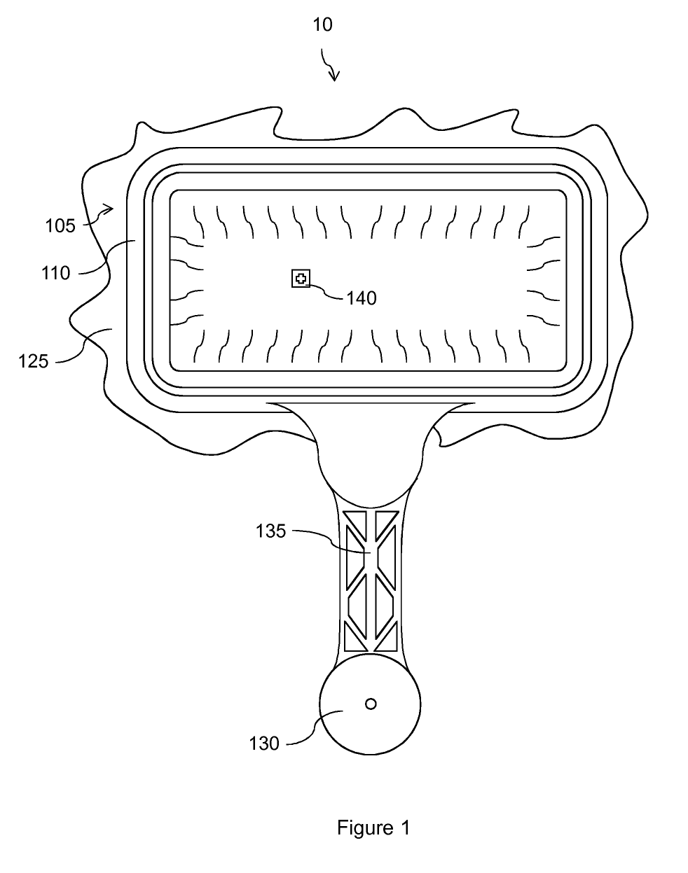

FIG. 1, which is to scale, shows a schematic view of an embodiment of the guide device 10 that is the subject of the present invention.

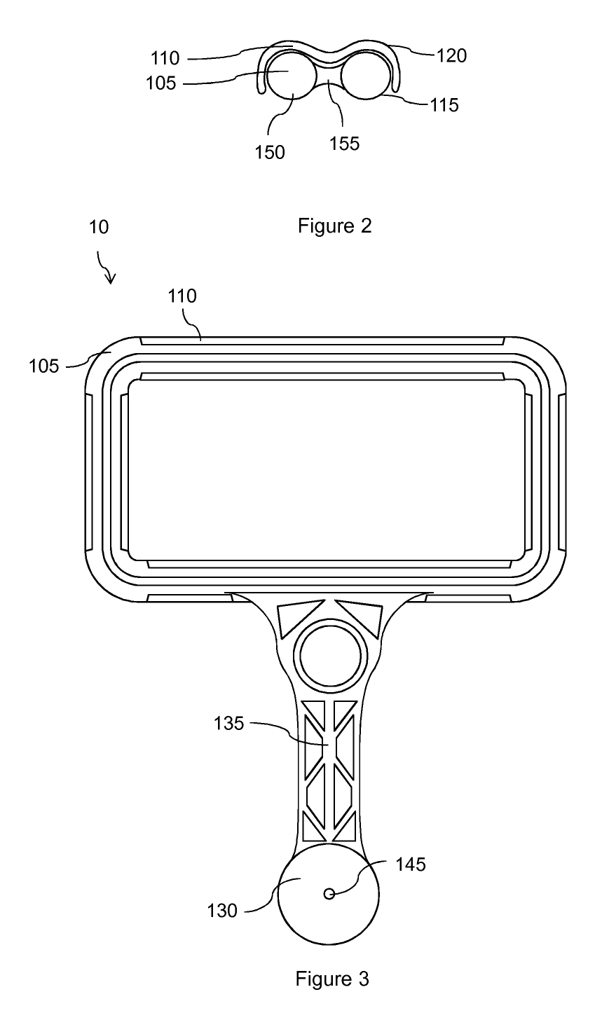

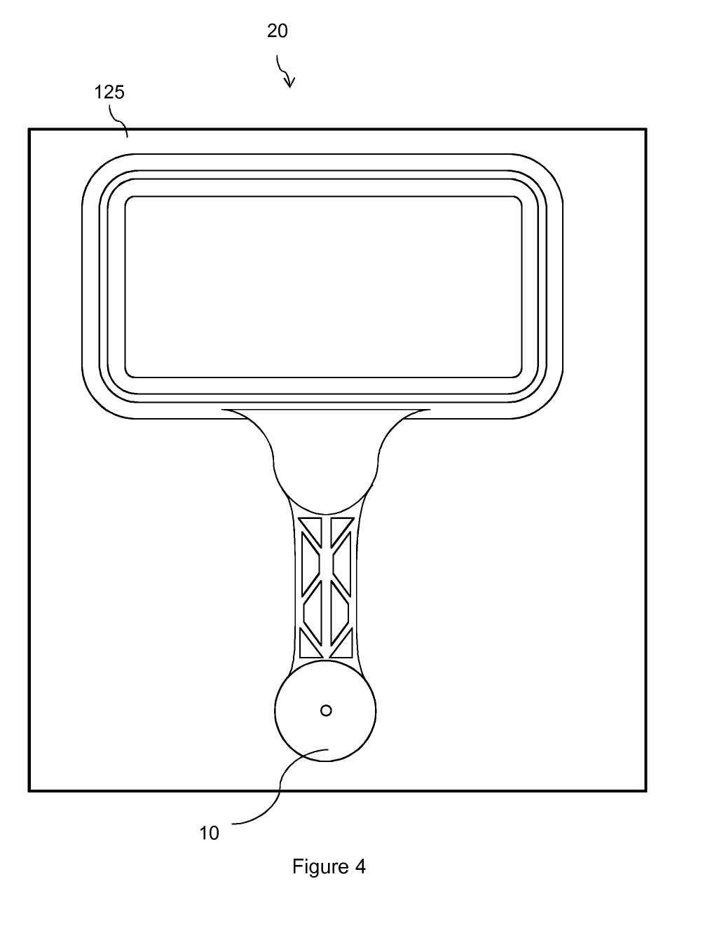

The guide device 10 comprises, on a closed contour, a peripheral jaw 105, referred to as “first jaw”, which follows the closed contour or is intermittent, eg only present in the four straight portions of the closed contour shown in FIG. 3. Preferably, the profile 115 of the first jaw 105 has constant dimensions. In the embodiment shown in FIG. 2, the first jaw 105 has a cross-section, or profile, 105 in the shape of an “8”, ie two disks 150 linked by a junction 155 that is thinner than the diameter of the disks.

Preferably, the periphery of the device 10 is planar. These embodiments enable the device to be positioned more easily against a flat surface, such as a wall, for example.

Preferably, the periphery of the device 10 has a broadly rectangular shape, with apexes rounded or flattened to form an octagon, so that the device 10 is easily placed horizontally against a wall. The periphery can be a rectangle.

In some preferred embodiments, the curvature of the profile 115 of the first jaw 105 changes sign at least twice. The profile 115 of the first jaw preferably has a shape comprising two extremities and a junction between the two extremities. The junction creates a depression in the profile 115. Preferably, the extremities are made of circular arcs and the junction comprises at least one circular arc of opposite curvature. Such a change of sign in the curvature of the profile 115 of the first jaw 105 results in effective clamping of an impervious film forming a bag for holding material. Preferably, the first jaw is made of PVC (acronym for “PolyVinyl Chloride”).

The device 10 comprises a removable jaw 110, referred to as “second jaw”, with a profile 120 that corresponds, at least partially, to the profile 115 of the first jaw 105, interlocking with the first jaw 105 and immobilizing a film 125 made of an impervious material. Preferably, the flexibility of the material from which the second jaw 110 is made allows the jaw 110 to be deformed by pressing manually. This elastic deformation allows the second jaw 110 to pass over the largest dimension of the profile 115 of the first jaw 105 and to stay in this nested position, in which the film 125 is clamped between the two jaws 105 and 110. The opening, ie the separation, of the jaws 105 and 110 is achieved by applying an opposite manual pressure.

Preferably, the profile 120 of the second jaw 110 has constant dimensions over the entire length of the jaw.

Preferably, both the first and second jaws are in a plane and have a broadly rectangular shape, with apexes possibly rounded or flattened to form an octagon. These embodiments enable the second jaw 110 to be positioned more easily on the first jaw 105.

In some preferred embodiments, the curvature of the profile 120 of the second jaw 110 changes sign at least twice, ie has two points of inflexion. Preferably, the extremities are made of circular arcs and the junction comprises at least one circular arc of opposite curvature. The profile 120 of the first jaw preferably has a shape comprising two extremities and a junction between the two extremities. Such a change of sign in the curvature of the profile 115 of the first jaw 105, ie a point of inflexion, results in effective clamping of the impervious film 125.

The curvature of the profile 120 is similar to the curvature of the profile 115 over at least one portion of the profile 120 so that the first and second jaws, 105 and 110, create a clamping of the impervious film 125.

Preferably, the profile 115 and the profile 120 have an axis of symmetry.

Preferably, the second jaw 110 is made of PVC (acronym for “PolyVinyl Chloride”).

The device 10 comprises a manipulating handle 130 connected to the first jaw 105 or, in a variant, to the second jaw 110, for manipulating the device 10. Preferably, the manipulating handle 130 is arranged on one of the longer sides of the rectangle defining the closed contour, to limit the gravitational force moment due to the material held in the impervious film 125. The manipulating handle 130 is elongated. The dimensions of the connection of the manipulating handle 130 to the first jaw 105 are smaller than the dimensions of the manipulating handle 130 in an axis perpendicular to the connection.

The manipulating handle 130 can comprise material reinforcements 135. The material reinforcements 135 are configured to withstand bending when a force is applied on the first jaw 105. The material reinforcements are additions at the location of the manipulating handle 130. Preferably, to better distribute forces, the material reinforcements 135 form a forty-five-degree angle to the direction of the bending forces.

The manipulating handle 130 can comprise a circular hole 145 allowing the device 10 to be suspended on a hook or a spike. Preferably, the manipulating handle 130 is thinner than the dimension of the nested profiles 115 and 120.

In some embodiments, the first jaw 105 and the second jaw 110 are articulated by a hinge. The hinge is preferably on one of the longer sides of the rectangle defining the periphery of the device and the opening of the bag formed by the film 125 clamped between the jaws 105 and 110. This hinge can be a thin elastic material link between the first jaw 105 and the second jaw 110. The hinge can be a interlocking of a shape of the first jaw 105 with a shape of the second jaw 110, configured to create a pivoting connection, such as a spindle and a hole for example.

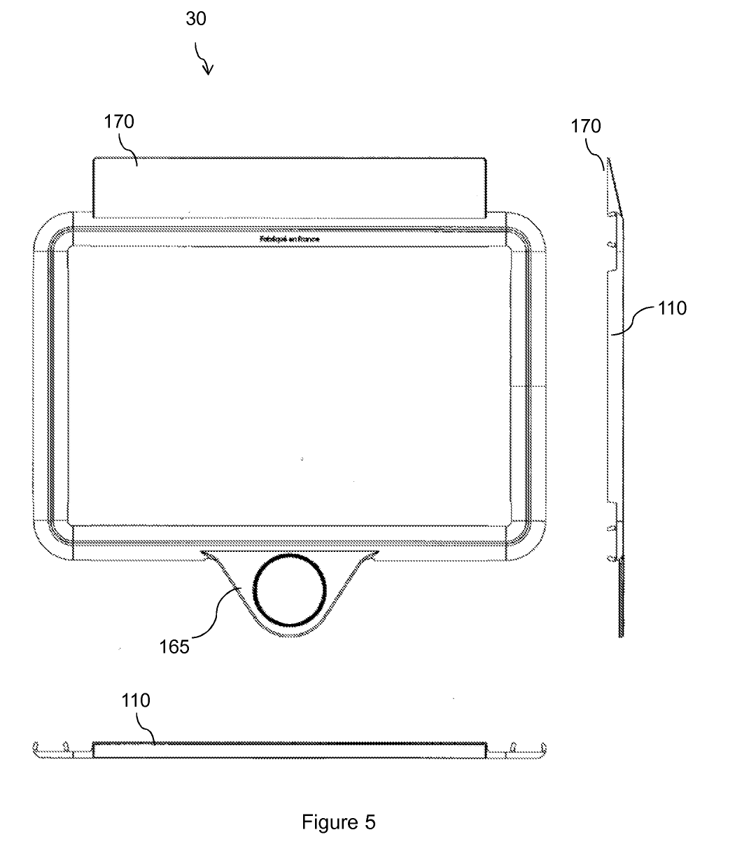

Preferably, the second jaw 110 comprises a cover 165 (see FIG. 5) at least partially covering the manipulating handle 130. Such a cover 165 enables the two jaws 105 and 110 to be kept closed during the manipulation of the object so as to keep the impervious film 125 in position.

Preferably, at least one jaw, 105 or 110, is produced by molding. The stamp for producing the mold corresponds to the first jaw 105 of the device 10 connected to the manipulating handle 130 and/or to the second jaw 110 of the device 10.

In some embodiments, the impervious film 125 comprises a drain valve 140. The drain valve 140 comprises an operable part configured to command the stopping or flowing of the liquid contained in the impervious bag. For example, the drain valve 140 can be connected to means for storing the liquid or for evacuating it to drains.

Preferably, the impervious film 125 is made of a plastic material at least partially transparent to visible wavelengths.

In some embodiments, the impervious film 125 is made of a plasticized textile, made of a flexible composite material and covered by a plasticized surface or in the form of a metallic film covered by a plasticized surface.

Preferably, the dimension of the profiles 115 and 120 nested along an axis perpendicular to the plane of the closed contour is less than one centimeter.

In some preferred embodiments, the device 10 can be used in the following cases:

draining radiators;

draining an underfloor heating manifold;

draining a hot- or cold-water manifold;

draining a water heater;

draining a boiler tank located near the floor;

cleaning plumbing outlets;

purging radiators, in a wall angle for example;

cleaning the drain of a household appliance requiring the circulation of a liquid, such as a washing machine or dishwasher;

draining a gas-fired boiler;

cleaning an oil filter in a heating-oil boiler; or

purging or draining automotive parts, such as brake drums for example.

In the cases mentioned above, the device 10 is placed close to the opening from which the liquid flows out. Given the small dimensions and ease of handling of the device 10, the device 10 can easily surround the opening and prevent any soiling of surrounding elements.

In addition, the capacity of material that can be held is defined by the dimensions of the impervious film 125. Because the impervious film 125 rests on a flat surface such as a floor or a workbench, for example, the material is distributed within the impervious film 125 without excessive stresses for the device 10. Once the material has been guided into the impervious film 125, the impervious film 125 can be closed, removed from the device 10 and moved to be discarded. In other embodiments, the impervious film 125 is emptied by means of the drain valve 140.

FIG. 4 shows a kit 20 comprising a guide device 10 that is the subject of the present invention, and at least one film 125 made of an impervious material forming an impervious bag. The dimensions of the film 125 are greater than the dimensions of the jaws of the guide device. Preferably, the film 125 takes the form of a bag, the perimeter of whose opening is greater than the perimeter of the jaws of the device 10, ie of a path passing through all the jaws. Preferably, the perimeter of the opening of the bag is between 105 and 150% of the perimeter of the jaws of the device 10.

FIG. 5 shows a variant 30 of the device 10, which comprises a spatula, or squeegee, 170 for scraping a base. This squeegee 170 allows material to be collected by dragging this squeegee 170 over a base of this material. The squeegee 170 is, preferably, on the opposite side from the manipulating handle 130.

The length, outer edge to outer edge, of the shorter side of the rectangular portion of the device 30 bearing the jaws is preferably between 15 and 25 centimeters and, even more preferably, between 17 and 23 centimeters. The length, outer edge to outer edge, of the longer side of the rectangular portion of the device 30 bearing the jaws is preferably between 21 and 35 centimeters and, even more preferably, between 24 and 32 centimeters.

In some embodiments, the device that is the subject of the present invention has feet, preferably retractable or removable, such that the device can stand on the floor with the opening of the impervious film kept at least twenty centimeters from the ground.

In some embodiments, the device that is the subject of the present invention is equipped with straps, ropes or wires, preferably removable, such that the device can be suspended, eg to a radiator, with the opening of the impervious film kept at least five centimeters from the fastening of the straps, ropes or wires.

In some embodiments, the device that is the subject of the present invention is equipped with a belt, preferably removable, such that the device can be kept on a user's hip. Preferably, the fastening between the jaws and the belt means that the angle between their planes is less than 60°. In this way, the opening of the film is kept open and the user can easily place material in the bag, without needing to open its opening.

In some embodiments, the device that is the subject of the present invention is equipped with a light source, an electrical power supply for this light source, and a switch, preferably positioned on the manipulating handle, to power the light source. The user can therefore light the work area, for example behind a water heater, hot-water tank or radiator, or under a sink, washbasin or bath, without having one of his hands occupied with a lamp. This light source is, preferably, a light-emitting diode.

1. Device for guiding material, notably liquid, comprising, on a closed contour:
a peripheral jaw, referred to as “first jaw”, having a profile;
a removable jaw, referred to as “second jaw”, with a profile that corresponds, at least partially, to the profile of the first jaw, interlocking with the first jaw to immobilize a film between said jaws; and
a manipulating handle secured to at least one of the jaws for manipulating the device.

2. Device according to claim 1, wherein the curvature of the profile of the first jaw changes sign at least twice.

3. Device according to claim 1, wherein the closed contour is planar.

4. Device according to claim 1, wherein the closed contour has a generally rectangular shape.

5. Device according to claim 1, wherein the manipulating handle comprises material reinforcements.

6. Device according to claim 1, wherein at least one jaw is made of PVC (acronym for “PolyVinyl Chloride”).

7. Device according to claim 1, wherein at least one jaw is produced by molding.

8. Device according to claim 1, wherein the impervious film comprises a drain valve.

9. Device according to claim 1, wherein the impervious film is made of a plastic material at least partially transparent to visible wavelengths.

10. Device according to claim 1, which comprises a spatula.

11. Device according to claim 1, wherein at least one of the jaws has a broadly rectangular shape, the length of the shorter side of this rectangle preferably being between 15 and 25 centimeters.

12. Device according to claim 1, wherein at least one of the jaws has a broadly rectangular shape, the length of the longer side of this rectangle preferably being between 21 and 35 centimeters.

13. Device according to claim 1, which has feet.

14. Device according to claim 1, which is equipped with suspension straps, ropes or wires.

15. Device according to claim 1, which is equipped with a belt.

16. Device according to claim 1, which is equipped with a light source, an electrical power supply for this light source, and a switch.

17. Kit comprising at least one device according to claim 1, and at least one bag made of an impervious material, the perimeter of whose opening is larger than the perimeter of the jaws of the guide device.

18. Kit according to claim 17, wherein the perimeter of the opening of the bag made of an impervious material is between 105 and 150% of the perimeter of the jaws of the device.
